(19) United States
(12) Patent Application Publication
(10) Pub. No.: US 2013/0298773 A1
(43) Pub. Date: Nov. 14, 2013

(54) DUST COLLECTION FILTER UNIT, PROJECTION IMAGE DISPLAY DEVICE, AND AIR CLEANER

(71) Applicants: Shigekazu Yamagishi, Osaka (JP); Hiroshi Sekido, Aichi (JP)

(72) Inventors: Shigekazu Yamagishi, Osaka (JP); Hiroshi Sekido, Aichi (JP)

(73) Assignee: PANASONIC CORPORATION, Kadoma-shi, Osaka (JP)

(21) Appl. No.: 13/981,555

(22) PCT Filed: Jan. 27, 2012
(86) PCT No.: PCT/JP2012/000542

§ 371 Date: Jul. 24, 2013

(30) Foreign Application Priority Data
Jan. 31, 2011 (JP) 2011-017544

(51) Int. Cl. B03C 3/34

(52) U.S. Cl. CPC B03C 3/34
USPC 96/15

(57) ABSTRACT

An dust collection filter unit 100 has a pleated filter 105 formed by folding a filter material, and a frame body 106 for which the pleated filter 105 is attached to the inside thereof, and in addition to these, has a support structure for the pleated filter 105. The support structure is provided inside the frame body 106, to support a plurality of folded portions of the pleated filter 105, thereby maintaining the shape of the pleated filter 105.

### TECHNICAL FIELD

The present invention relates to a dust collection filter unit using a pleated filter for capturing dust, a projection image display device using the dust collection filter unit, and an air cleaner using the dust collection filter unit.

### BACKGROUND ART

Conventionally, a projection image display device concentrates intense light from a light source onto image display elements such as a liquid crystal panel or a digital mirror device (DMD), modulates the concentrated light in accordance with the image signal, and enlarges and projects an image formed on the image display elements, to obtain a large screen. In the projection image display device, a large amount of heat generation occurs on the image display elements subjected to intense light, the light source, the device power supply, and the like, and they are thermally destroyed unless they are cooled properly. Therefore, the projection image display device is configured so as to cool the inside of the device by introducing external air to the inside of the device through a fan.

However, in this configuration, dust together with external air is introduced from the outside of the device to the inside of the device. Then, if the dust adheres to the image display elements or the vicinity of the light source, brightness reduction or color unevenness can occur. Therefore, in general, a dust collection filter for suppressing dust entry is provided at an air inlet. Such a dust collection filter is needed for not only the projection image display device but also other devices such as an air cleaner. As a dust collection filter, an urethane foam filter is generally used. The urethane foam filter can be reused by performing filter cleaning per several hundred hours of use. However, since the urethane foam filter is coarse, pollen or minute dust equal to or smaller than 1 μm cannot be captured.

Accordingly, in order to capture such minute dust, an electrostatic filter is employed. The electrostatic filter is a filter medium formed by an electrically charged chemical fiber and capable of capturing minute dust by using static electricity. The electrostatic filter is coarse, and therefore has a merit that pressure loss of passing air is small. However, in the electrostatic filter, the dust collection efficiency due to electric charge effect is reduced by dust adhesion with increase in usage time. In the electrostatic filter, dust can be removed by cleaning with water, but electric charge on the fiber surface is also lost, so that the dust collection efficiency reduces to an extremely low level. Therefore, there is a problem that the electrostatic filter cannot be reused and becomes a throwaway filter. In response to this problem, a renewable electrostatic filter is proposed (Patent Literature 1 and Patent Literature 2).

### CITATION LIST

### Patent Literature

[PTL 1] Japanese Laid-Open Patent Publication No. H05-154318

[PTL 2] Japanese Laid-Open Patent Publication No. 2008-93501

### SUMMARY OF THE INVENTION

### Problems to be Solved by the Invention

In general, as a dust collection filter attached to an air inlet of a device such as a projection image display device or an air cleaner, a pleated filter is often employed in order to prolong a filter exchange period with a limited area. The pleated filter is a filter formed by zigzag folding a filter material. A conventional pleated filter has a hardness allowing its shape to be maintained by the single pleated filter alone, and for example, the outer circumference thereof is supported by a frame body.

On the other hand, the renewable electrostatic filter includes a cloth material (for example, unwoven cloth) composed of two or more kinds of different chemical fibers, and is recharged by friction between the chemical fibers. Therefore, in such an electrostatic filter, chemical fibers cannot be fixed, and therefore the electrostatic filter is flexible and its shape is likely to be deformed. In such an electrostatic filter, it is difficult to maintain the shape thereof by only the cloth material, and if the electrostatic filter is left for a while in a pleated shape, the shape is deformed. In particular, if cleaning work is conducted, deformation of the shape is significant.

Such deformation of shape can occur not only in the renewable electrostatic filter but also in the flexible pleated filter. In the conventional support structure which supports the outer circumference of the pleated filter, the shape of the flexible pleated filter is greatly deformed, and the deformation of the shape causes a problem that an area for capturing dust is reduced or an area to which dust adheres becomes partial.

Therefore, an object of the present invention is to provide a dust collection filter unit, a projection image display device using the dust collection filter unit, and an air cleaner using the dust collection filter unit, which can solve such a problem of shape deformation of the pleated filter.

### Solution to the Problems

In order to solve the above problem, a dust collection filter unit of the present invention includes: a pleated filter formed by folding a filter material; a frame body having a ventilation hole to which the pleated filter is attached; and support means provided on the ventilation hole and configured to support a plurality of folded portions of the pleated filter, thereby maintaining the shape of the pleated filter.

Typically, in the dust collection filter unit, the support means may include a plurality of support poles supported by the frame body and supporting the respective different folded portions. The folded portions of the pleated filter may be fixedly adhered to the support poles. The folded portions of the pleated filter may be embedded in the support poles. The outer circumferential portion of the pleated filter may be embedded in the frame body. The pleated filter may be embedded in the frame body and the support poles by insert molding upon molding of the frame body and the support poles.

The pleated filter may be configured to satisfy L/P≦3, where L is the height difference (the length in mountain-valley direction of the pleated filter) between mountain and valley in the case where each folded portion is mountain or valley, and P is the folding pitch between the adjacent folded portions on one surface side of the pleated filter.

The pleated filter may have: a filter portion on an air intake side where air enters, the filter portion being configured to capture dust; and a reinforcing net on an air discharge side where air for which dust has been eliminated by the filter portion is discharged, the reinforcing net being more difficult to sag than the filter portion and reinforcing the filter portion. A portion functioning as an electrostatic filter, of the pleated filter, may be composed of a mixed fiber including at least two kinds of synthetic fibers. The thickness of the pleated filter is 1 mm or more.

The support poles may be formed being integrated with the frame body. The plurality of support poles may be provided for some of the plurality of folded portions of the pleated filter. The support poles on an air inlet side of the pleated filter may be provided for every other folded portions on the air inlet side of the plurality of folded portions. Of the plurality of support poles, the number of supported poles supporting the folded portions on an air discharge side of the pleated filter may be less than the number of support poles supporting the folded portions on an air intake side of the pleated filter. The support poles may have concave portions formed thereon, the concave portions not supporting the pleated filter and each provided between portions supporting the folded portions of the pleated filter.

The dust collection filter unit may be provided on an air intake portion of a projection image display device. The dust collection filter unit may be provided on an air intake portion of an air cleaner.

### Advantageous effects of the Invention

According to the present invention, since the plurality of folded portions of the pleated filter are supported to maintain the shape of the pleated filter, it becomes possible to suppress reduction in the function of the pleated filter due to deformation of the shape.

By using this dust collection filter unit for a projection image display device, it becomes possible to suppress reduction in brightness and occurrence of color unevenness due to dust adhesion, with a high dust collection performance, over a long period. In addition, in the case of using a renewable electrostatic filter, it becomes possible to suppress maintenance cost by cleaning and renewing the filter even if clogging occurs by dust.

### BRIEF DESCRIPTION OF THE DRAWINGS

FIG. 1 is a sectional view of an air cleaner according to embodiment 1.

FIG. 2 is a cross-sectional view of a dust collection filter unit according to embodiment 1.

FIG. 3 is a perspective view of a filter frame, where an electrostatic filter is omitted, according to embodiment 1.

FIG. 4 is an enlarged view of a folded portion of the electrostatic filter, according to embodiment 1.

FIG. 5 is a diagram for explaining an optimum value of LIP in the electrostatic filter.

FIG. 6 is a perspective view showing another example 1of the dust collection filter unit according to embodiment 1, where the electrostatic filter is omitted.

FIG. 7 is a cross-sectional view showing another example 2 of the dust collection filter unit according to embodiment 1.

FIG. 8 is a perspective view showing another example 3 of the dust collection filter unit according to embodiment 1, where the electrostatic filter is omitted.

FIG. 9 is a schematic structure diagram showing a projection image display device according to embodiment 2.

FIG. 10 is a sectional view of a dust collection filter unit according to embodiment 2.

### DESCRIPTION OF EMBODIMENTS

### Embodiment 1

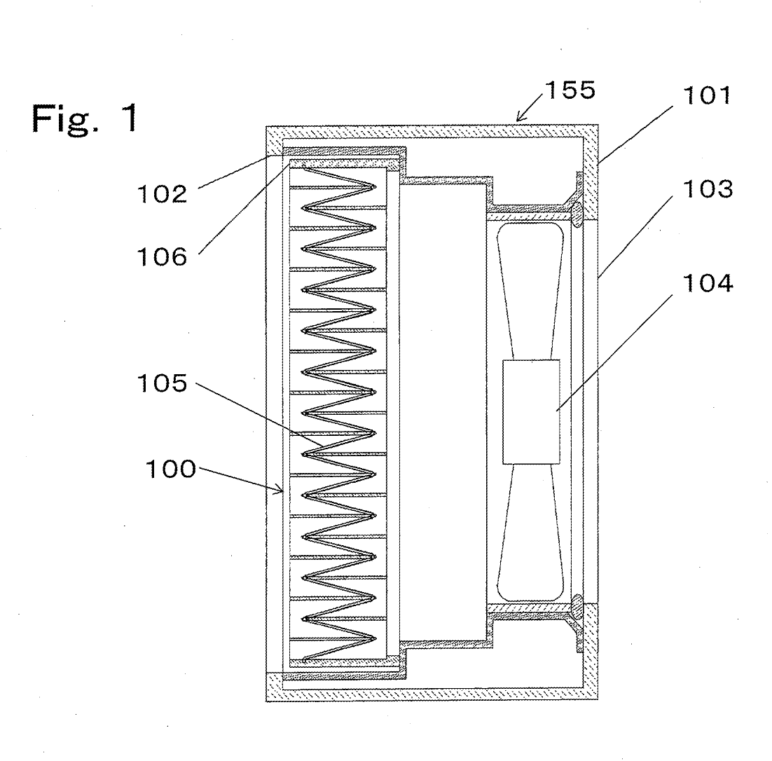

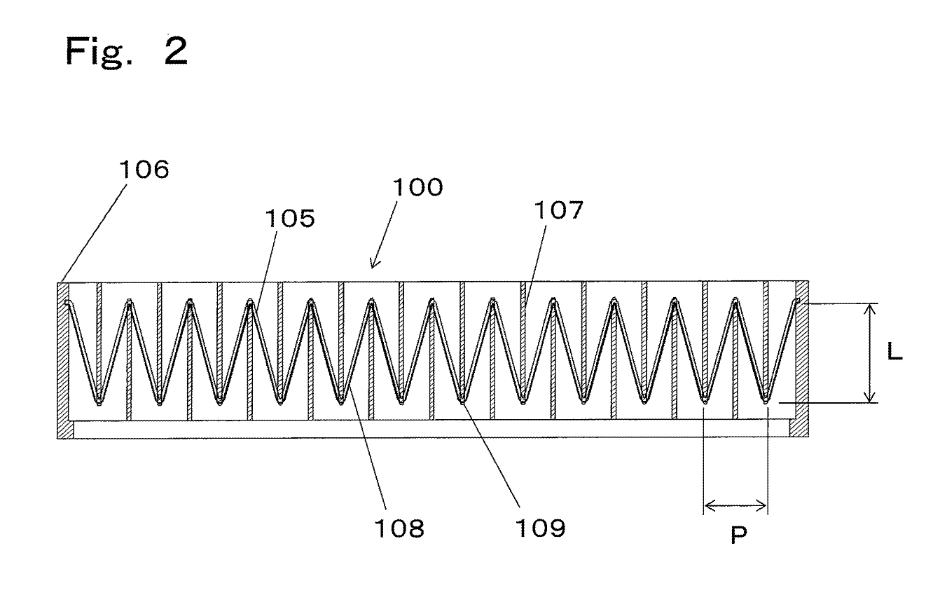

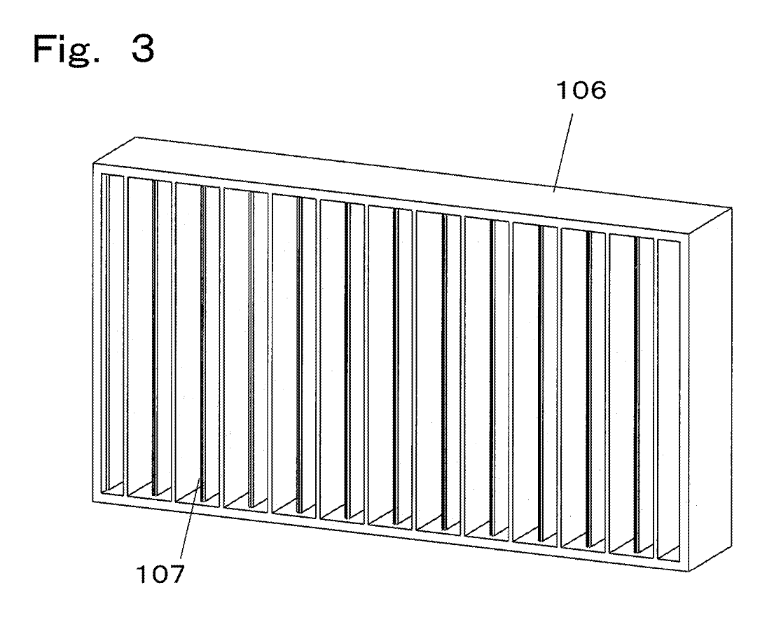

FIG. 1 is a sectional view of an air cleaner 155 according to embodiment 1 of the present invention, FIG. 2 is a sectional view of a dust collection filter unit 100 provided therein, and FIG. 3 is a perspective view of a filter frame 106, where an electrostatic filter 105 is omitted. A housing 101 has an air intake portion 102 and an air discharge portion 103. Inside the housing 101, an axial flow fan 104 driven by an external power supply, and the dust collection filter unit 100 placed on the air intake side with respect to the axial flow fan 104, are provided. The dust collection filter unit 100 has the electrostatic filter 105, and the filter frame 106 having a ventilation hole to which the electrostatic filter 105 is to be attached.

In the dust collection filter unit 100, the outer circumferential portion of the electrostatic filter 105 is embedded in the filter frame 106 by insert molding. In order to maintain the electrostatic filter 105 in a pleated shape (a folding shape of alternately making mountain and valley), the electrostatic filter 105 is inserted upon molding of the filter frame 106 so that the outer circumferential portion (peripheral portion) of the electrostatic filter 105 is embedded in resin of the filter frame 106. The insert molding is a molding method of molding the filter frame 106 by resin in the state in which the electrostatic filter 105 is inserted into the mold of the filter frame 106. The outer circumference of the electrostatic filter 105 is embedded in the filter frame 106 by insert molding, and as a result, no gap occurs at the outer circumferential portion of the ventilation hole of the filter frame 106. Therefore, air from the air intake portion 102 is prevented from reaching the air discharge portion 103 without passing through the electrostatic filter 105. The filter frame 106 is configured to be attachable to and detachable from the housing 101.

Owing to the above configuration, when external air taken in through the air intake portion 102 of the housing 101 is passed through the electrostatic filter 105 having a pleated shape by rotation of the axial flow fan 104, dust in the external air can be captured on the electrostatic filter 105. The air after dust has been thus removed is discharged from the air discharge portion 103 of the housing 101, whereby cleaned air can be provided. By configuring the electrostatic filter 105 as a pleated filter having a pleated shape as described above, the filter air passage area can be enlarged, and a time until clogging occurs due to the captured dust can be prolonged.

FIG. 2 is an enlarged view of the dust collection filter unit 100 having the electrostatic filter 105 provided on the filter frame 106. At the mountain folded portions (vertex portions) forming the pleat in the electrostatic filter 105, support walls 107 (plate-like supporting poles (slit poles)) are formed at the same time as the molding of the filter frame 106. By thus integrating the electrostatic filter 105 and the support walls 107, the electrostatic filter 105 is fixed to be maintained in a pleated shape.

The support walls 107 are provided for all the folded portions (portions including the vertices of folding and the near portions). Some of the plurality of support walls 107 form air intake side support walls extending on the air intake side of the filter frame 106 along the air flowing direction, and the others form air discharge side support walls extending on the air discharge side of the filter frame 106 along the air flowing direction. In the air discharge side end portion of the air intake side support wall 107, the folded portion (valley folded portion in the case where the dust collection filter unit 100 is put with its air intake side facing upward as shown in FIG. 2) of the electrostatic filter 105 is embedded. In the air intake side end portion of the air discharge side support wall 107, the folded portion (mountain folded portion in the case where the dust collection filter unit 100 is put with its air intake side facing upward as shown in FIG. 2) of the electrostatic filter 105 is embedded. These folded portions are fixedly adhered to the respective support walls 107. A part of the support wall 107, which is integrated with the electrostatic filter 105, is a support portion 109. In addition, the outer circumferential portion of the electrostatic filter 105 is embedded in the filter frame 106. The electrostatic filter 105 is fixedly adhered to the filter frame 106. It is noted that as described above, the electrostatic filter 105 is embedded in the filter frame 106 and the support walls 107 by insert molding upon molding of the filter frame 106 and the support walls 107.

It is noted that the electrostatic filter 105 includes an unwoven cloth portion (filter portion) formed by a mixed fiber material of two kinds of different synthetic fibers, and a reinforcing net 108 for supporting the unwoven cloth portion. The reinforcing net 108 is integrated with the unwoven cloth portion so as to cover one surface of the unwoven cloth portion. The reinforcing net 108 is a net more difficult to sag than the unwoven cloth portion. By providing the reinforcing net 108, shape deformation of the electrostatic filter 105 is suppressed. In the electrostatic filter 105, the reinforcing net is positioned on the air discharge side of the unwoven cloth portion. It is noted that the number of the kinds of the synthetic fibers used for the electrostatic filter 105 may be three or more.

Here, in the case of a normal electrostatic filter, if the filter is cleaned when the ventilation performance is deteriorated due to accumulation of dust while dust is captured, the electrostatic force is also removed. Therefore, the electrostatic filter cannot be reused by cleaning, and after the ventilation performance of the electrostatic filter is deteriorated, the electrostatic filter is discarded. However, in the case of the electrostatic filter 105 according to the present embodiment 1, even if the electrostatic force is temporarily removed by cleaning, the electrostatic force is restored by friction between the two kinds of different synthetic fibers. That is, if the electrostatic filter 105 according to the present embodiment 1 is cleaned when the ventilation performance is deteriorated due to accumulation of dust while dust is captured, similarly, the electrostatic force is temporarily removed, but after the electrostatic filter 105 is dried, the electrostatic force is restored by causing friction between the different kinds of synthetic fibers, whereby dust collection performance can be obtained again.

It is noted that it is desirable to perform treatment such as kneading the electrostatic filter 105 in order to cause friction between the synthetic fibers. However, even by causing air passage in the state where the dust collection filter unit 100 is attached on the housing 101 again, friction occurs between the synthetic fibers by a certain degree of air movement, whereby the electrostatic force is restored. It is noted that in order to cause friction between the synthetic fibers by air movement, it is necessary to allow the synthetic fibers to move to some extent without fixing them. The electrostatic filter 105 is a flexible unwoven cloth, and therefore moves and swings along with the air passage. Therefore, the thickness thereof including the reinforcing net 108 for shape maintenance is 1 mm or more which is thicker than about 0.3 to 0.4 mm of a normal electrostatic filter. In addition, regarding the pitch of a conventional pleated filter, about 5 mm is most common irrespective of the depth. However, in the electrostatic filter 105 according to the present embodiment 1, even if the reinforcing net 108 is added for the above-described reason, the elasticity (toughness) is weak and the shape is unstable. Therefore, it is difficult to maintain the shape of the electrostatic filter 105. Accordingly, as shown in FIG. 2, it is desirable that the electrostatic filter 105 is configured to satisfy L/P≦3, where L is the height difference (the length in the pleat depth direction) between mountain and valley in the case where each folded portion is mountain or valley, and P is the folding pitch (the pitch between pleat mountains) between the adjacent folded portions on the one surface side of the electrostatic filter 105. This point will be described.

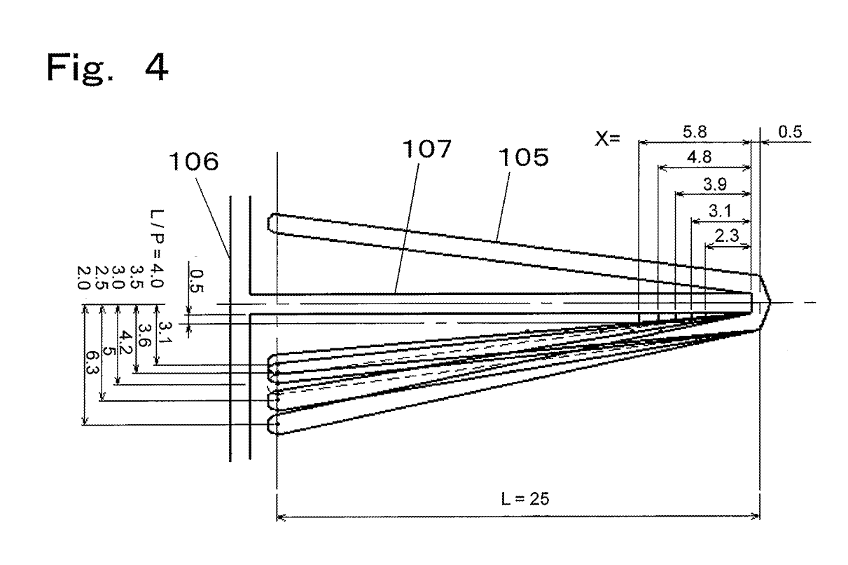

If the value of L/P is large, the filter area becomes large relative to the ventilation hole (ventilation portion opening) of the filter frame 106. However, if L/P is too large, a portion near the folded portion of the electrostatic filter 105 contacts the support wall 107, whereby a dust collection capability reduced region arises in which dust collection capability is reduced. FIG. 4 shows the attachment state of the folded portion of the electrostatic filter 105 when the height difference (the length in mountain-valley direction of the electrostatic filter 105 (filter medium)) (L) between mountain and valley in the case where each folded portion is mountain or valley is 25 mm. In FIG. 4, the folded portion of the electrostatic filter 105 contacts the right side of the support wall 107. Dimensions written at the left indicate the opening amount (P/2) of half pitch corresponding to each value of L/P, and dimensions written at the right indicate the length of a portion that becomes a dust collection capability reduced region due to contact with the support wall 107 by sag of the electrostatic filter 105. Regarding the dimensions at the right, 5.8 corresponds to L/P=4.0, 4.8 corresponds to L/P=3.5, 3.9 corresponds to L/P=3.0, 3.1 corresponds to L/P=2.5, and 2.3 corresponds to L/P=2.0.

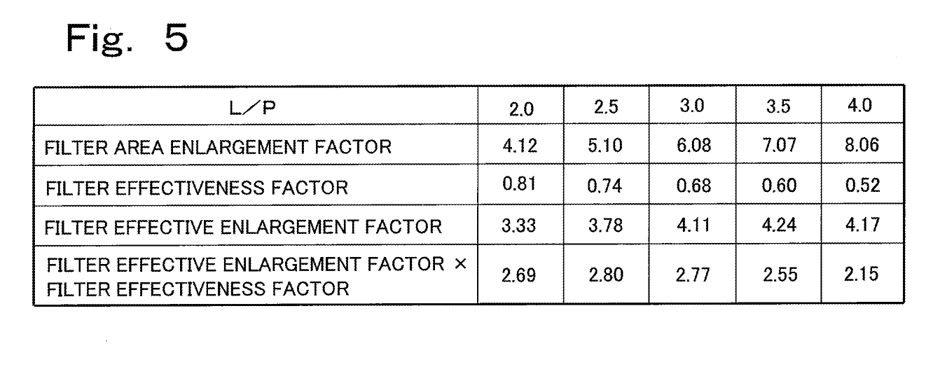

FIG. 5 shows a filter area enlargement factor and the like in the case where the dimension and the like of the electrostatic filter 105 are assumed from the precondition that can be considered to be most general. Regarding the dimension and the like in the case of FIG. 5, the height difference (L) between mountain and valley in the case where each folded portion is mountain and valley is 25 mm, the thickness of the electrostatic filter 105 is 1 mm, and the thickness of the support wall 107 is 1 mm. In addition, the sag amount of the electrostatic filter 105 is assumed to be half (0.5 mm) of the thickness of the electrostatic filter 105. It is noted that although FIG. 4 shows the values at any mountain portion, similar sag occurs also on the filter left end in this figure, and loss due to this sag occurs. Therefore, the range of a filter invalid portion is two times of the range (X) shown in FIG. 4.

A filter area enlargement factor A is represented by expression 1, a filter effectiveness factor B is represented by expression 2, and a filter effective enlargement factor C is represented by expression 3.

A=√{L²+(P/2)²}/(P/2) Expression 1

B=(L−2×X)/L Expression 2

C=A×B Expression 3

It is desirable that the electrostatic filter 105 is overall judged by the filter effective enlargement factor with respect to the ventilation hole area and the filter effectiveness factor relevant to cost. In view of the function of the electrostatic filter 105, it is desirable that the filter effective enlargement factor is large, and in view of the cost, it is desirable that the filter effectiveness factor is large. Judging from a value D (D=B×C) obtained by multiplying the filter effective enlargement factor by the filter effectiveness factor, D greatly reduces if L/P is larger than 3. Thus, it is found that L/P≦3 is desirable. In addition, since D is maximized at L/P=2.5, 2≦L/P≦3 is further desirable.

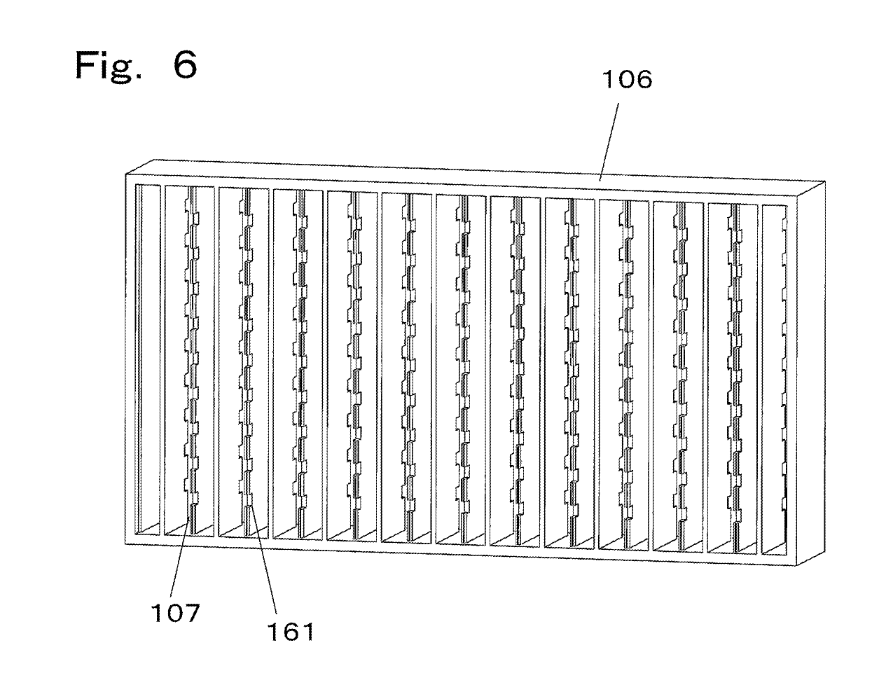

In addition, FIG. 3 is a perspective view in which the electrostatic filter 105 is removed in order to facilitate the understanding of the structure of the filter frame 106. Here, it is desirable that, of the support wall 107, the support portion 109 integrated with the electrostatic filter 105 is as short as possible in the height direction of the support wall 107 so that, of the electrostatic filter 105, the effective region functioning as a filter will not be reduced. As shown in FIG. 6, if a part of the support wall 107 is formed into a concave portion 161 so as to be away from the filter, an invalid region that cannot be used as a filter can be reduced. The concave portion 161 is formed on a side of the support wall 107 where the electrostatic filter 105 is embedded with respect to the thickness direction of the filter frame 106. Such a concave portion 161 may be provided on a support pole 110 described later. In addition, instead of embedding the electrostatic filter 105 in the support wall 110, the electrostatic filter 105 may be fixedly adhered to the support wall 110 by an adhesive agent. In addition, instead of fixedly adhering the electrostatic filter 105 to the support wall 110, the support wall 110 may contact the electrostatic filter 105, whereby the shape of the electrostatic filter 150 may be maintained.

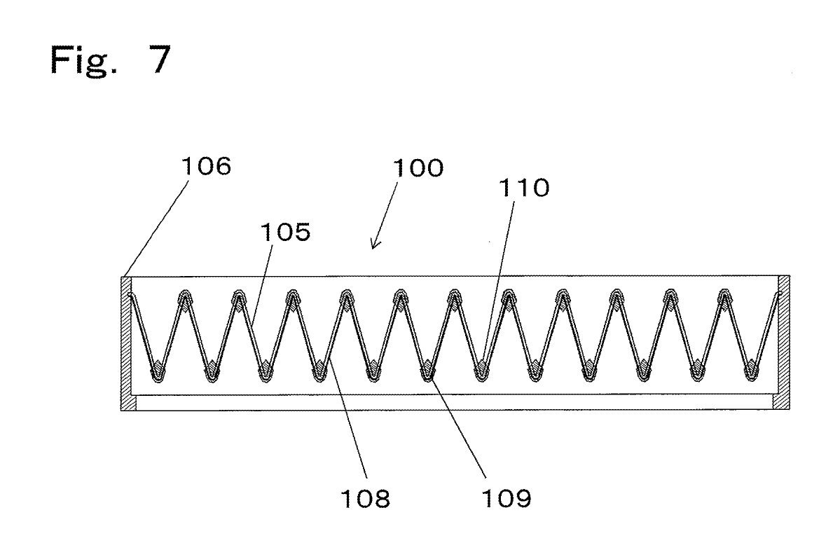

FIG. 7 shows still another example of the filter frame 106. In FIG. 7, instead of the support walls 107, support poles 110 for supporting the electrostatic filter 105 are formed to be as small as possible, and the filter frame 106 is formed so as to give as less influence as possible on ventilation. In the sectional view, the support pole 110 only occupies the folded portion and the neighborhood region thereof.

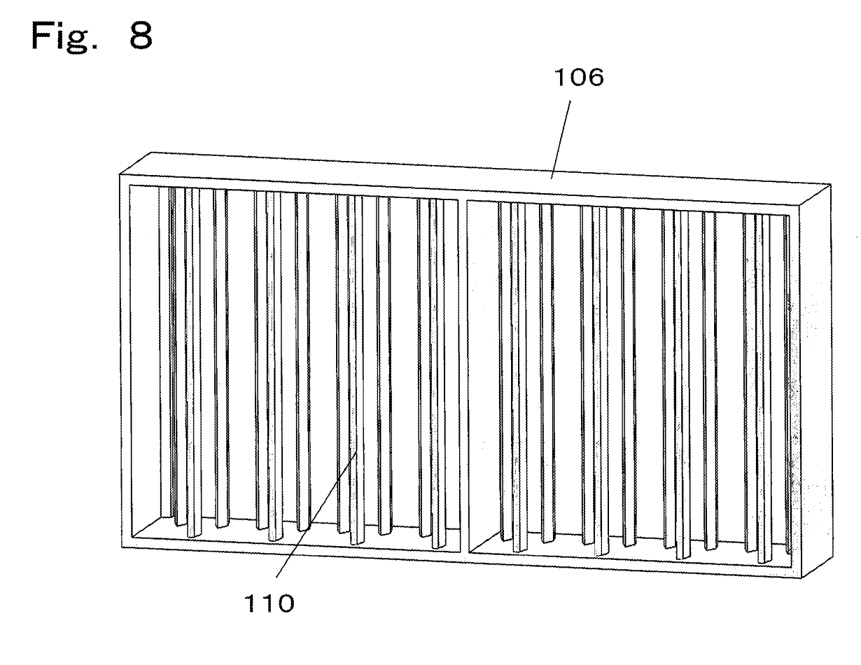

Further, the support poles 110 may be provided only for some of the plurality of folded portions of the electrostatic filter 105. For example, as shown in FIG. 8, the support poles 110 may be provided for every other folded portion of the plurality of folded portions on the air inlet side of the electrostatic filter 105. FIG. 8 is a perspective view of the filter frame 106 as seen from the air intake side, in which the electrostatic filter 105 is removed in order to facilitate the understanding. Thus, by providing the support poles 110 at every other mountain of the pleated shape, loss of the effective region of the electrostatic filter 105 due to the support described above is suppressed.

In addition, regarding the plurality of support poles 110, the number of the support poles supporting the folded portions on the air discharge side of the electrostatic filter 105 may be equal to or less than the number of the support poles 110 supporting the folded portions on the air intake side of the electrostatic filter 105. The necessity of the support poles 110 largely depends on not performance but a factor of external appearance. Therefore, particularly, on the air intake side which is easily viewable from outside, the support poles 110 may be provided at every other mountain of the pleated shape, and on the air discharge side, the number of the support poles 110 may be less than on the air intake side. Thus, increase in the invalid region of the electrostatic filter 105 can be suppressed.

Thus, according to embodiment 1, since the shape of the electrostatic filter 105 is maintained by supporting the plurality of folded portions of the electrostatic filter 105 having a pleated shape, reduction in the function of the electrostatic filter 105 due to deformation of the shape can be suppressed. In addition, by forming the electrostatic filter 105 in a pleated shape, the air cleaner 155 for which maintenance management is easy can be provided.

In addition, the configuration of the dust collection filter unit 110 described above is also effective for a projection image display device 150 shown below. In addition, instead of the electrostatic filter 105, a flexible dust collection filter that captures dust by a mesh without using static electricity may be used.

### Embodiment 2

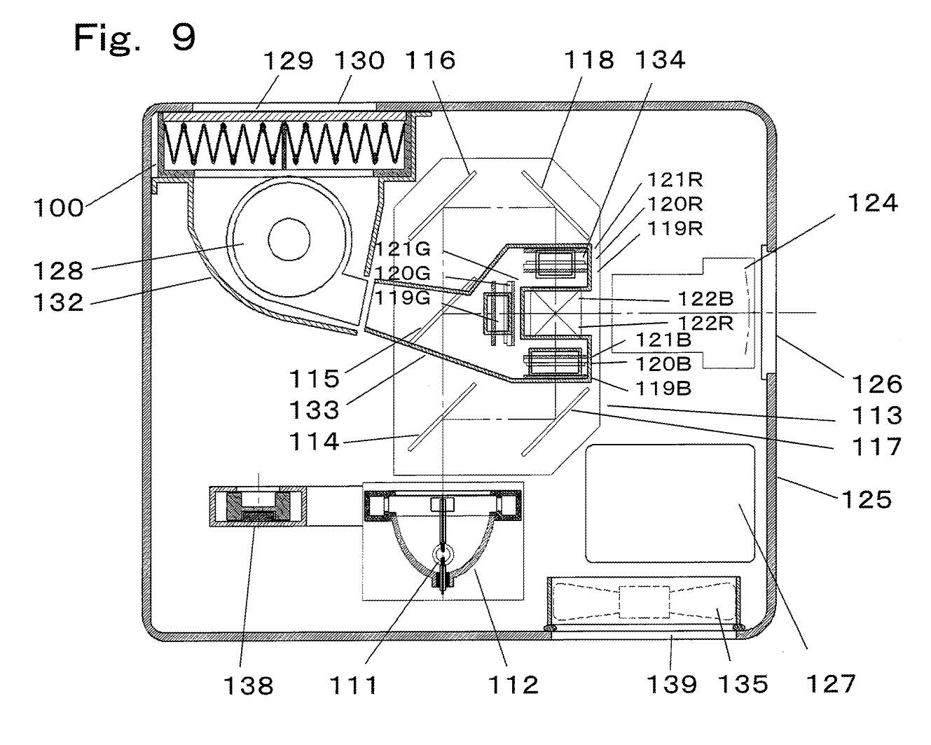

FIG. 9 is a diagram showing the structure of the projection image display device 150 according to embodiment 2 of the present invention. The present invention does not relate to an optical configuration. Therefore, the optical configuration will be briefly described below.

In the projection image display device 150, light emitted from a light source 111 is caused to travel forward by a light reflection mirror 112, and then enters an optical unit 113. The light entering the optical unit 113 passes through dichroic mirrors 114 and 115 and total reflection mirrors 116, 117, and 118, thereby to be divided into color lights of red, green, and blue, and then the intensity of each light is modulated, in accordance with an input signal from outside (not shown), by entry side polarization plates 119R, 119G, and 119B, liquid crystal panels 120R, 120G, and 120B, and exit side polarization plates 121R, 121G, and 121B. These lights are synthesized onto one optical path by a synthesizing prism including dichroic reflection films 122R and 122B, and the synthesized light enters a projection lens 124. The projection lens 124 is designed and placed so that images on the liquid crystal panels 120R, 120G, and 120B can be enlarged and projected, through dust proof glass 126 attached on the opening of a housing 125, onto a screen (not shown) placed in front.

In the projection image display device 150, in order to perform black display, it is necessary to absorb light from the light source 111 by the entry side polarization plates 119R, 119G, and 119B and the exit side polarization plates 121R, 121G, and 121B, and as a result, high temperature occurs along with the absorption. On the other hand, since the polarization plates 119R, 119G, 119B, 121R, 121G, and 121B are mainly made of an organic material, the properties thereof are transformed unless they are cooled to an appropriate temperature. If the properties of the polarization plates 119R, 119G, 119B, 121R, 121G, and 121B are transformed, image control cannot be performed, leading to an unusable state. Besides these, inside the projection image display device 150, the bulb of the light source which can reach 1000 degree Celsius upon light emission, peripheral mechanism components, a power supply 127 for the light source or image display, also cause large self-heating. Therefore, the projection image display device 150 needs cooling means for ensuring the reliability.

In the present embodiment, by an air intake fan 128 which is a blower portion, external air (air with a relatively low temperature) is introduced to the inside of the housing 125 through an air inlet 129 provided on the side surface of the housing 125, a pre-filter 130, and the dust collection filter unit 100. The air forced by the air intake fan 128 contained in an air intake duct 132 is introduced into an optical unit duct 133 placed in close contact with the blow-off outlet of the fan. In the optical unit duct 133, an opening for blue, an opening for green, and an opening 134 for red are provided at positions under the entry side polarization plates 119R, 119G, and 119B, the liquid crystal panels 120R, 120G, and 120B, and the exit side polarization plates 121R, 121G, and 121B. The air introduced into the optical unit duct 133 is blown into the optical unit 113 through these openings. The air blown through these openings takes heat of the entry side polarization plates 119R, 119G, and 119B, the liquid crystal panels 120R, 120G, and 120B, and the exit side polarization plates 121R, 121G, and 121B, and thereafter, also takes heat of the light source 111, the peripheral mechanism components thereto, and the power supply 127 in the process of air drawing by an air discharge fan 135, and further, owing to the operation of a lamp sirocco fan 138.

Furthermore, since a light source drive circuit (not shown) and a video signal circuit (not shown) also generate heat, the thermal design of the projection image display device 150 is made such that these circuits are also cooled at the same time.

The air after reaching the air discharge fan 135 is blown off to the outside of the housing 125 through an air outlet 139 provided in the housing 125.

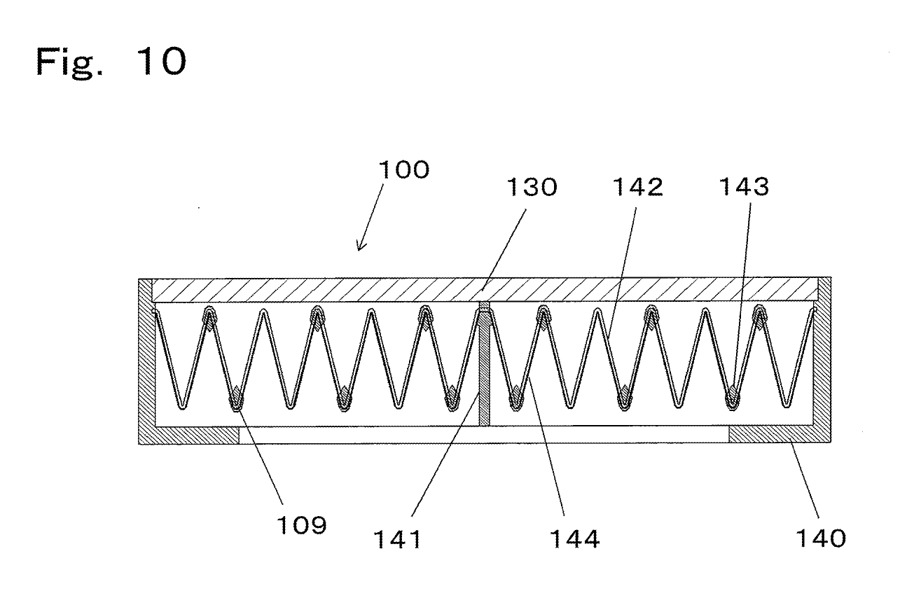

In the present embodiment 2, the pre-filter 130 is provided on the air intake side of the same dust collection filter unit 110 as that shown in embodiment 1. The pre-filter 130 itself is configured to be extremely unlikely to be clogged in order to prolong the clogging time, and a filter (for example, an extremely low pressure loss filter of 3M company) having a structure that an electrically charged film is made up into an extremely coarse honeycomb form, is used for the pre-filter 130. As shown in FIG. 10, the pre-filter 130 is supported by being pressed into the air intake side ends of a filter frame 140.

Here, the filter frame 140 has a partition 141 at its center for increasing the strength. The inside of the filter frame 140 is divided into two rooms by the partition 141. In an electrostatic filter 142, support poles 143 are formed at the mountain-folded vertex portions of the pleated structure, at the same time as the molding of the filter frame 140. The electrostatic filter 142 is fixedly adhered to the support poles 143. By thus integrating the electrostatic filter 142 and the support poles 143, the electrostatic filter 142 is fixed and its pleated shape is maintained.

It is noted that as in embodiment 1, also the electrostatic filter 142 includes an unwoven cloth portion formed by a mixed fiber material of two kinds of different synthetic fibers, and a reinforcing net 144 for supporting the unwoven cloth portion. Also in the electrostatic filter 142, if the filter is cleaned when the ventilation performance is deteriorated due to accumulation of dust while dust is captured, the electrostatic force is temporarily removed, but after the electrostatic filter 142 is dried, the electrostatic force is restored by causing friction between the different kinds of synthetic fibers, whereby dust collection performance can be obtained again. Also regarding the restoration, as in embodiment 1, it is desirable to perform treatment such as kneading the electrostatic filter 142. However, even by causing air passage in the state where the dust collection filter unit 100 is attached on the housing 125 again, friction occurs between the fibers by air movement upon air intake, whereby the electrostatic force is restored. It is noted that in order to cause friction between the synthetic fibers by air movement, it is necessary to allow the synthetic fibers to move to some extent without fixing them. Therefore, the thickness thereof including the reinforcing net 144 for shape maintenance is 1 mm or more which is thicker than the thickness of a normal electrostatic filter. In addition, similarly to the description in FIG. 2, the electrostatic filter 142 is also configured to satisfy L/P≦3, where L is the length in the pleat depth direction and P is the pitch between pleat mountains. If the pitch P is small, the filter itself is narrow, and therefore ventilation performance is lost particularly in the vicinity of the folding vertex. Further, also in view of external appearance, if the value P is small, sag of the filter stands out well even if the sag is small.

In addition, the reinforcing net 144 is placed on the air discharge side of the electrostatic filter 142. Thus, even if a fiber should be dropped off from the electrostatic filter 142, the fiber can be prevented from being drawn into the inside of the projection image display device 150.

As in embodiment 1, it is desirable that of the support pole 143, the support portion 109 integrated with the electrostatic filter 142 is as small as possible so that, of the electrostatic filter 142, the effective region functioning as a filter will not be reduced. In addition, naturally, it is also effective here to reduce an invalid region that cannot be used as a filter by forming a part of the support wall 143 into a concave portion so as to be away from the filter. Further, removal of some of the support poles 143 is also possible as shown in FIG. 10.

### INDUSTRIAL APPLICABILITY

The present invention can be used for manufacture, selling, and the like of a dust collection filter unit, a projection image display device using the dust collection filter unit, and an air cleaner using the dust collection filter unit.

### DESCRIPTION OF THE REFERENCE CHARACTERS

100, 131 dust collection filter unit
101, 125 housing
102 air intake portion
103 air discharge portion
104 axial flow fan
105, 142 electrostatic filter
106 filter frame
107 support wall
108, 144 reinforcing net 109 support portion
110, 143 support pole
111 light source
112 reflection mirror
113 optical unit
114, 115 dichroic mirror
116, 117, 118 total reflection mirror
119R, 119G, 119B entry side polarization plate
120R, 120G, 120B liquid crystal panel
121R, 121G, 121B exit side polarization plate
122R, 122B dichroic reflection film
124 projection lens
126 dust proof glass
127 power supply
128 air intake fan
129 air inlet
130 pre-filter
132 air intake duct
133 optical unit duct
134 opening for red
135 air discharge fan
138 lamp sirocco fan
139 air outlet
140 filter frame
141 partition
150 projection image display device
155 air cleaner
161 concave portion

1-17. (canceled)

18. A dust collection filter unit comprising:
a pleated filter formed by folding a filter material;
a frame body, the pleated filter being attached to the inside thereof; and
support members provided inside the frame body and configured to support a plurality of folded portions of the pleated filter, thereby maintaining the shape of the pleated filter, wherein
the support members include a plurality of support poles supported by the frame body and supporting the respective different folded portions,
the pleated filter is a flexible electrostatic filter having: a filter portion on an air intake side where air enters, the filter portion being configured to capture dust; and a reinforcing net on an air discharge side where air for which dust has been eliminated by the filter portion is discharged, the reinforcing net being more difficult to sag than the filter portion and reinforcing the filter portion, and
the filter portion is composed of a mixed fiber including at least two kinds of different synthetic fibers, wherein
the folded portions of the pleated filter are fixedly adhered to the support poles.

19. The dust collection filter unit according to claim 18, wherein
the folded portions of the pleated filter are embedded in the support poles.

20. The dust collection filter unit according to claim 18, wherein
the outer circumferential portion of the pleated filter is embedded in the frame body.

21. The dust collection filter unit according to claim 18, wherein
the pleated filter is embedded in the frame body and the support poles by insert molding upon molding of the frame body and the support poles.

22. The dust collection filter unit according to claim 18, wherein
the pleated filter is configured to safety 2≦L/P≦3, where L is the height difference between mountain and valley in the case where each folded portion is mountain or valley, and P is the folding pitch between the adjacent mountain folded portions on one surface side of the pleated filter.

23. The dust collection filter unit according to claim 18, wherein
the thickness of the pleated filter is 1 mm or more.

24. The dust collection filter unit according to claim 18, wherein
the support poles are formed being integrated with the frame body.

25. The dust collection filter unit according to claim 18, wherein
the plurality of support poles are provided for some of the plurality of folded portions of the pleated filter.

26. The dust collection filter unit according to claim 25, wherein
the support poles on an air inlet side of the pleated filter are provided for every other folded portions on the air inlet side of the plurality of folded portions.

27. The dust collection filter unit according to claim 18, wherein
of the plurality of support poles, the number of supported poles supporting the folded portions on an air discharge side of the pleated filter is less than the number of support poles supporting the folded portions on an air intake side of the pleated filter.

28. The dust collection filter unit according to claim 18, wherein
the support poles have concave portions formed thereon, the concave portions not supporting the pleated filter and each provided between portions supporting the folded portions of the pleated filter.

29. A projection image display device comprising:
the dust collection filter unit according to claim 18 which is provided at an air intake portion.

30. An air cleaner comprising:
the dust collection filter unit according to claim 18 which is provided at an air intake portion.
